(19) United States
(12) Patent Application Publication
(10) Pub. No.: US 2021/0394959 A1
(43) Pub. Date: Dec. 23, 2021

(54) MULTI-FUNCTIONAL BOTTLE WITH REUSABLE DINING ATTACHMENTS

(71) Applicants: Joseph Nazarian, Aliso Viejo, CA (US); Jeremy Glassman, Tempe, AZ (US)

(72) Inventors: Joseph Nazarian, Aliso Viejo, CA (US); Jeremy Glassman, Tempe, AZ (US)

(21) Appl. No.: 16/903,621

(22) Filed: Jun. 17, 2020

(51) Int. Cl. B65D 23/12; A45F 3/16; B65D 23/10; A47J 41/02; C02F 1/00; A47G 19/22; A47G 21/02

(52) U.S. Cl. CPC B65D 23/12; A45F 3/16; B65D 23/104; A47J 41/02; C02F 2307/02; A47G 19/2205; A47G 19/2283; A47G 21/02; A45F 2003/163; C02F 1/003

(57) ABSTRACT

A reusable, multi-functional reusable bottle for reducing the amount of plastic waste generated by single-use utensils and single-use water bottles. The multi-functional reusable bottle efficiently and conveniently packages durable, reusable utensils for repeated use, eliminating the need for single-use utensils or bottled water. The multi-functional reusable bottle may be equipped with a magnetic removeable plate, at least one collapsible utensil, a removable cup, one or more straws and/or sip tips, a carbon filter liquid purifier, and any combinations thereof. In addition, the multi-functional reusable bottle may preferably be vacuum sealed, include a side strap for easy carrying, and be made of a durable metal that is washable and reusable over prolonged periods of time.

### FIELD OF USE

The present disclosure relates generally to the field of reusable insulated bottles, and more specifically to a multi-functional reusable insulated bottle that includes various reusable dining attachments for minimizing user's plastic consumption footprint.

### BACKGROUND

Insulated bottles are regularly used as a convenient way to store and transport water or other beverages. Various types of reusable bottles with more advanced features have become increasingly popular, such as those that include liquid filtration units, insulation, or are reusable and designed for long-term use.

However, currently existing reusable bottles remain severely limited in their ability to reduce the plastic footprint of their users. This is because the currently available reusable bottles are frequently used in connection with disposable eating utensils, namely plastic forks, spoons, and knives. Reusable bottle users frequently bring their bottles when traveling, which is an inconvenient and unsanitary time to store and use reusable flatware. As a result, the users may frequently use disposable utensils, despite that user's concern for the environment.

Furthermore, currently available reusable bottles are limited in functionality and features. Although there are reusable bottles that provide, for example, water filtration and vacuum insulation, these bottles are not available with an eating surface, reusable utensils, and cups.

Thus, there is a need for a reusable, multi-functional bottle that effectively reduces the plastic footprint of users by eliminating the need to use disposable eating utensils, while simultaneously providing a high-quality bottle that is durable, reusable, thermally insulated, and has a filtration system.

### SUMMARY

To minimize the limitations in the cited references, and to minimize other limitations that will become apparent upon reading and understanding the present specification, the reusable, multi-functional bottle and attachments disclosed herein disclose a multi-function, reusable bottle that may be equipped with reusable dining attachments designed to eliminate a user's need for single use bottled water, plastic utensils, plates, and cups. In addition to reducing a user's plastic consumption footprint, the multi-functional reusable bottle of the present disclosure may provide a high-quality beverage container for all of the user's reusable bottle needs.

One embodiment may be a multi-functional container, comprising an interior space configured to hold a liquid, a removable cup, a utensil storage insert, a reusable utensil, a magnetic plate, and a cap assembly, wherein the utensil storage insert may be configured to removably receive the reusable utensil, and wherein the removable cup, utensil storage insert, magnetic plate, and cap assembly may be configured to removeably connect to the bottle. The reusable utensil may include one or more pivot points, such that the reusable utensil may compact by rotating along the pivot points. The reusable utensil may be selected from the group of utensils consisting of, forks, knives, spoons, and/or sporks. The removable cup may engage a bottom portion of the bottle. The removable cup and the bottom portion of the bottle may be configured to threadedly engage one another. The utensil storage insert may engage a bottom portion of the bottle. The utensil storage insert and the bottom portion of the bottle may be configured to frictionally engage one another. The utensil storage insert may engage an inner surface of the bottom portion of the bottle. The removable cup and an outer surface of the bottle may be configured to threadedly engage one another. The removable cup may be larger in diameter than the utensil storage insert, such that the removable cup slides over and encompasses the utensil storage insert when both the removable cup and the utensil storage insert may be engaged with the bottle. The bottom portion of the bottle may be flat, such that the bottle may be capable of standing upright on flat surfaces when the removable cup may be removed from the bottle. The bottle, removable cup, magnetic plate, utensil storage insert, and reusable utensil may be made of metal. In other embodiments, the removable cup, utensil storage insert, and reusable utensil may be made of high-grade washable and reusable plastic. The bottle may be vacuum insulated. The cap assembly may further include a first straw. The cap assembly may further include a second straw. The multi-functional container apparatus may further include a liquid filtration apparatus attached to or integrated with the cap assembly.

Embodiments of the present disclosure may further include a reusable, multi-functional bottle geared towards reducing the amount of plastic waste generated by single-use utensils or single-use water bottles. The multi-functional reusable bottle efficiently and conveniently packages durable, reusable utensils for repeated use, eliminating the need for single-use utensils or bottled water. The multi-functional reusable bottle may be equipped with a magnetic plate, collapsible utensil, a removable cup, one or more straws, a carbon filter liquid purifier, and any combinations thereof. In addition, the multi-functional reusable bottle may preferably be vacuum sealed and/or insulated, include a side strap for easy carrying, and/or may be made of a durable metal that may be washable and reusable over prolonged periods of time.

One embodiment may be a multi-functional reusable bottle with reusable dining attachments, comprising: a bottle; a removable cup; a utensil storage insert; a reusable utensil; a magnetic plate; and a cap assembly.

One embodiment may be a multi-functional reusable bottle with reusable dining attachments, wherein the reusable utensil(s) may be one or more of the following: a fork, a knife, a spoon, and/or a spork. Preferably, the reusable utensil(s) is foldable along a central pivot point, such that the reusable utensil folds approximately in half for easy storage within the utensil storage insert.

One embodiment may be a multi-functional reusable bottle with reusable dining attachments, wherein the utensil storage insert, and removable cup may be securely and reversibly attached to separate portions of the bottle, preferably by screw threading. In this embodiment, the utensil storage insert and removable cup may be attached or removed to the bottle independently of each other, allowing users to selectively access and use either the reusable utensil(s) and/or the removable cup.

In one embodiment, the multi-functional reusable bottle may be vacuum insulated, such that the bottle is capable of maintaining the temperature of its contents for extended periods of time.

Another embodiment may be a multi-functional reusable bottle, wherein the cap assembly further comprises one or more straws. The multi-functional reusable bottle may be further equipped with a liquid filtration apparatus.

Other features and advantages inherent in the multi-functional reusable bottle with reusable dining attachments of the present disclosure, besides those which are claimed and disclosed, will become apparent to those skilled in the art from the following detailed description and its accompanying drawings.

### BRIEF DESCRIPTION OF THE DRAWINGS

The drawings are of illustrative embodiments. They do not illustrate all embodiments. Other embodiments may be used in addition or instead. Details which may be apparent or unnecessary may be omitted to save space or for more effective illustration. Some embodiments may be practiced with additional components or steps and/or without all of the components or steps, which are illustrated. When the same numeral appears in different drawings, it refers to the same or like components or steps.

FIG. 1 is an illustration of an assembled view of one embodiment of the multi-functional reusable bottle with reusable dining attachments.

FIG. 2 is an illustration of an exploded view of one embodiment of the multi-functional reusable bottle with reusable dining attachments.

FIG. 3 is an illustration of a side view of one embodiment of the multi-functional reusable bottle showing the removable plate.

FIG. 4 is a cross-section view of one embodiment of the multi-functional reusable bottle.

FIG. 5 is an illustration of a one embodiment of the multi-functional reusable bottle showing the removeable cup.

FIG. 6 is an illustration of one embodiment of the removeable plate.

FIG. 7 is an illustration of a perspective view of one embodiment of a collapsible spork for use with the multi-functional reusable bottle of the present disclosure.

FIG. 8 is an illustration of a side view of one embodiment of a collapsible spork for use with the multi-functional reusable bottle of the present disclosure.

FIG. 9 is an illustration of one embodiment of a utensil storage containing the collapsible spork.

FIG. 10 is an exploded view of one embodiment of a cap assembly for use with the multi-functional reusable bottle of the present disclosure.

FIG. 11 is a perspective view of one embodiment of a cap assembly for use with the multi-functional reusable bottle of the present disclosure.

FIG. 12 is an illustration of one embodiment of a carbon filter for use with a multi-functional reusable bottle.

FIG. 13 is an illustration of one embodiment of a disassembled view of the multi-functional reusable bottle.

### DETAILED DESCRIPTION OF THE ILLUSTRATIVE EMBODIMENTS

In the following detailed description, numerous specific details are set forth in order to provide a thorough understanding of various aspects of one or more embodiments. However, these embodiments may be practiced without some or all of these specific details. In other instances, well-known methods, procedures, and/or components have not been described in detail so as not to unnecessarily obscure aspects of embodiments.

While multiple embodiments are disclosed, still other embodiments will become apparent to those skilled in the art from the following detailed description. As will be realized, these embodiments are capable of modifications in various obvious aspects, all without departing from the spirit and scope of protection. Accordingly, figures and the detailed descriptions thereof are to be regarded as illustrative in nature and not restrictive. Also, the reference or non-reference to a particular embodiment shall not be interpreted to limit the scope of protection.

In the following description, certain terminology is used to describe certain features of one or more embodiments. For purposes of the specification, unless otherwise specified, the term “substantially” refers to the complete or nearly complete extent or degree of an action, characteristic, property, state, structure, item, or result. For example, in one embodiment, an object that is “substantially” located within a housing would mean that the object is either completely within a housing or nearly completely within a housing. The exact allowable degree of deviation from absolute completeness may in some cases depend on the specific context. However, generally speaking, the nearness of completion will be so as to have the same overall result as if absolute and total completion were obtained. The use of “substantially” is also equally applicable when used in a negative connotation to refer to the complete or near complete lack of an action, characteristic, property, state, structure, item, or result.

As used herein, the terms “approximately” and “about” generally refer to a deviance of within 5% of the indicated number or range of numbers. In one embodiment, the term “approximately” and “about,” may refer to a deviance of between 0.0001-10% from the indicated number or range of numbers.

The present specification discloses a multi-functional reusable bottle with reusable dining attachments for minimizing the user's plastic consumption footprint.

Disclosed are components that may be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all embodiments of this application including, but not limited to, steps in disclosed methods. Thus, if there are a variety of additional steps that may be performed it is understood that each of these additional steps may be performed with any specific embodiment or combination of embodiments of the disclosed methods.

In the following description, certain terminology is used to describe certain features of one or more embodiments.

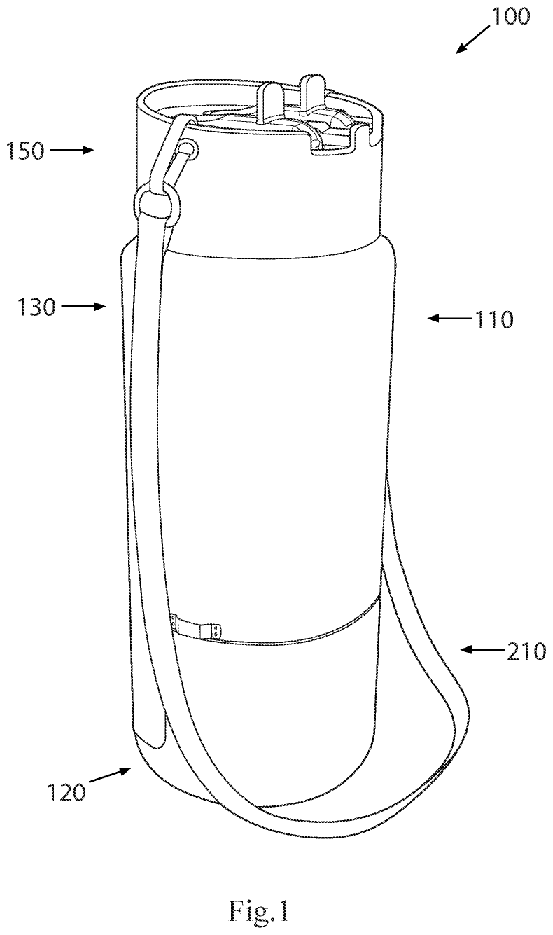

FIG. 1 is an illustration of an assembled view of one embodiment of the multi-functional reusable bottle with reusable dining attachments. As shown in FIG. 1, the multi-functional reusable bottle 100 may comprise a container 110, a removable cup 120, cap assembly 150, and carrying strap 210, which may allow for easy transport and handling. The bottle 100 may preferably be durable and reusable. In one embodiment, the container 110 of the bottle 100 may be insulated and or vacuum sealed, such that liquids contained therein maintain their temperature (cold or hot) for an extended period of time. The carrying strap 210 may be removably affixed to the multi-functional reusable bottle 100, such as by using straps, clips, or other securing mechanisms.

As shown in FIG. 1, the removable cup 120 may be designed to appear as an extension or component of the container 110, such that the function of the removable cup 120 may not be readily apparent upon an initial viewing. In one embodiment, the cap assembly 150 may threadedly engage an opening at the top of the bottle 100, and when twisted on, may seal the bottle 110. Preferably, the removable cup 120 may screw onto the bottle 110 via threading, although a simple sliding friction fit may also be used, or any other mechanical coupling mechanism may be used.

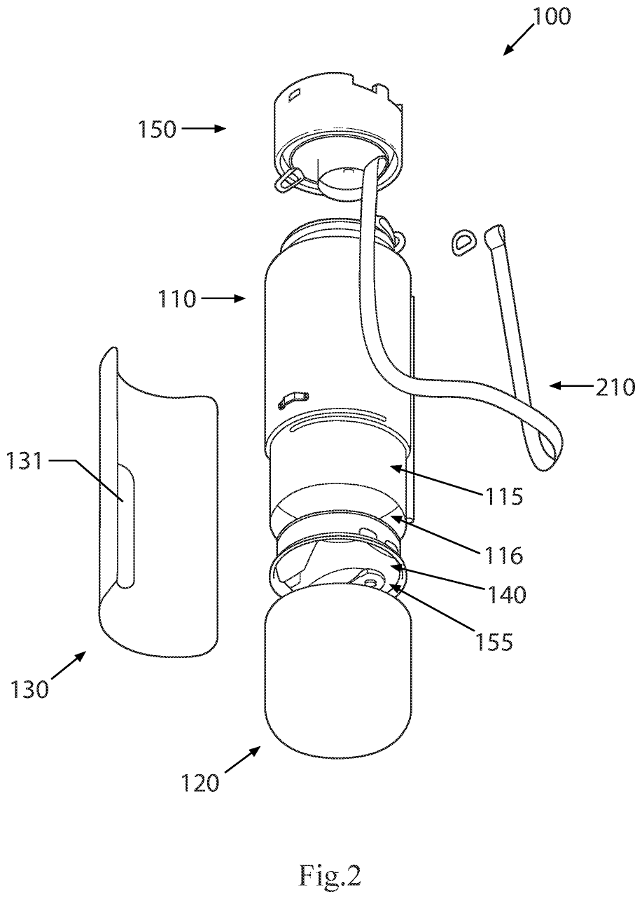

FIG. 2 is an illustration of an exploded view of one embodiment of the multi-functional reusable bottle with reusable dining attachments. As shown in FIG. 2, the multi-functional reusable bottle 100 may comprise a container 110, a removable cup 120, a removeable plate 130, cap assembly 150, carrying strap 210, utensil storage insert 140, and reusable and collapsible utensil 155. to be placed, further comprising a reusable utensil(s) 155. As shown, the utensil 155 fits snuggly, but removeably within the insert 140, which itself fits snuggly, and preferably removeably, within or at a bottom of the container 110. As shown, the removable cup 120, when attached to the bottom of the bottle 100 may cover and conceal the insert 140. The removeable plate 130 may rest substantially flush against the container 110 and be held in place via one or more magnets. In various embodiments, the magnet portion may be on the inner surface of the plate 130 and/or the outer surface of the container 110. When the magnets are on both the plate 130 and the container 110, the plate may be held very securely against the side of the container 110. In one embodiment, the entire plate 130 may be magnetic and the bottle 110 may be a ferrous metal to which a magnetic substance may attract. In alternate embodiments, the plate 130 may be a non-magnetic material and may affix to the container 110 through some other attachment mechanisms, such as friction clipping around a curve of the bottle 110.

The plate 130 may be easily removed and re-attached to the side of the container 110. The magnetic plate 130 may be durable and washable, such that it may be used multiple times over the lifetime of the multi-functional reusable bottle 100. In one embodiment, the removeable plate 130 may be substantially curved in order to engage the bottle 110 and comprise at least one flat portion 131 that may allow the magnetic plate 130 to be stable on a flat surface. The flat portion 131 may also double as the magnetic portion.

When the removable cup 120 is secured to the bottom of the bottle 100, preferably, the removable cup 120 may be attached to the bottle 100 at an attachment point 115 that is narrower than the rest of the container 110. In this manner, the completely assembled multi-functional reusable bottle 100 may have a smooth appearance when seen from afar, with a near-consistent diameter from top to bottom.

The bottom of the container 110 may have a structure that comprises a substantially hollow portion 116 with an opening facing down such that the utensil storage insert 140 may engage the substantially hollow portion 116. The utensil storage insert 140 may engage the substantially hollow portion via friction or some other connection mechanism. Additionally, the bottom of the container 110 may have an outward threaded portion configured to receive and secure the removable cup 120. In alternative embodiments, various mechanical attachment mechanisms may be used to secure the reusable cup 120 and the utensil storage insert 140 to the container 110.

In an alternative embodiment, the utensil storage insert 140 may be a part of the bottle 110, and not a separate component that removeably affixes to the container 110.

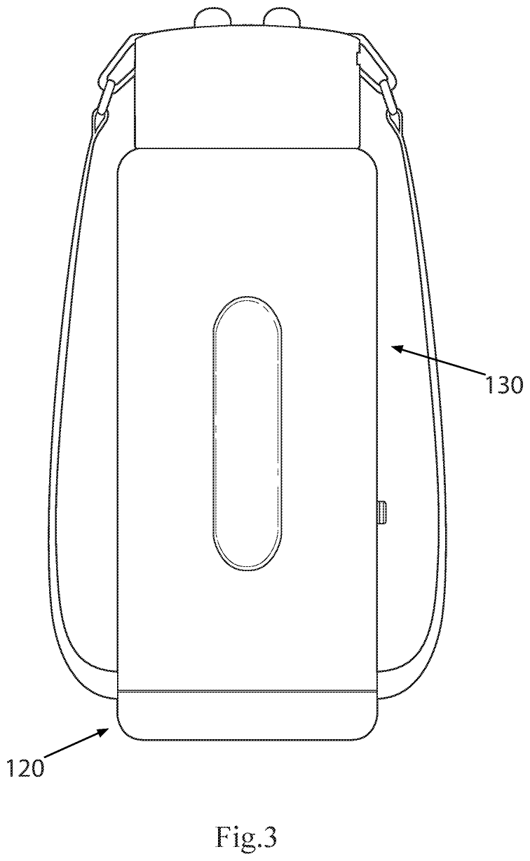

FIG. 3 is an illustration of a side view of one embodiment of the multi-functional reusable bottle showing the removable plate. As shown the removeable plate 130 may extend from the top of container 110 to the removeable cup 120.

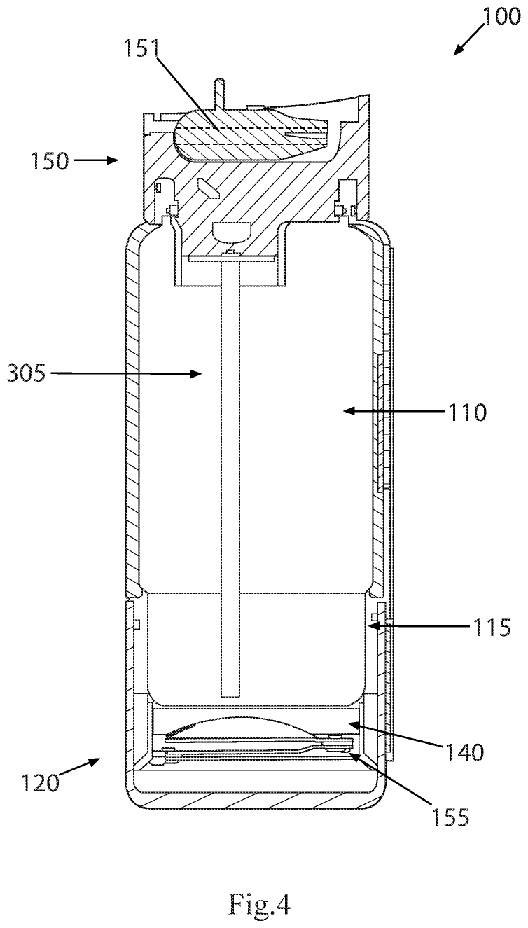

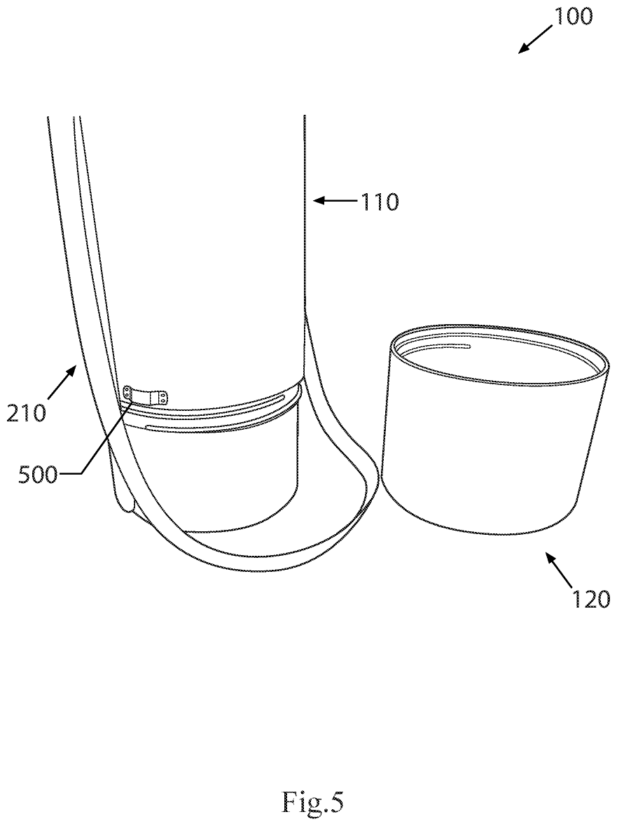

FIG. 4 is a cross-section view of one embodiment of the multi-functional reusable bottle. FIG. 4 shows the container is substantially hollow and configured to hold a liquid. The cap assembly 150 may have one or more sip tips 151. The cap assembly may also include a straw 305, which allows a user to drink from the bottle 100 without tipping it. The straw 305 may be removed and may be clipped to the outside of the bottle via a clip, such as clip 500 shown in FIG. 5. FIG. 4 also shows how the cap 120 may cover insert 140 and utensil 155, and how the cap 120 and container 120 have an outer surface that are flush with each other. In one embodiment, the straw 305 may be a water filtration straw.

FIG. 5 is an illustration of a one embodiment of the multi-functional reusable bottle showing the removeable cup. FIG. 5 shows that the removable cup 120 has been removed from container 110 and that they may be threadedly reconnected. FIG. 5 also shows the strap 210 may be a removeable lanyard. FIG. 5 shows that the outer surface of the container 110 may have a clip 500, which may be used to attach various devices to the container 110. One such device may be a reusable and removeable straw. As shown in FIG. 5, the bottom portion of the bottle 110, which may be covered by the removable cap 120, is flat so that the bottle 100 may stand upright even when the removable cap 120 is removed.

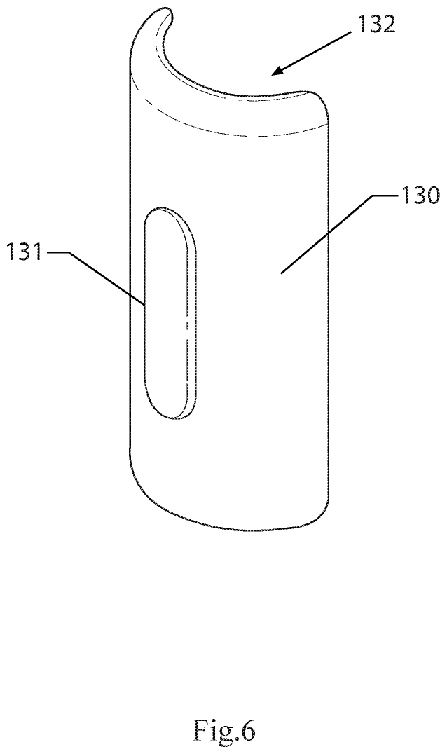

FIG. 6 is an illustration of one embodiment of the removeable plate. The removeable plate 130 may be configured to matingly and conformingly engage with the outside of container 110. The plate may have a shoulder portion 132 that may matingly engage with the shoulder of the container 110. Taken together, the reusable plate, cup, and utensil attachments provided by the multi-functional reusable bottle 100 eliminate the necessity for the user to use single-use plates, cups, or flatware, thereby significantly reducing a user's plastic consumption footprint.

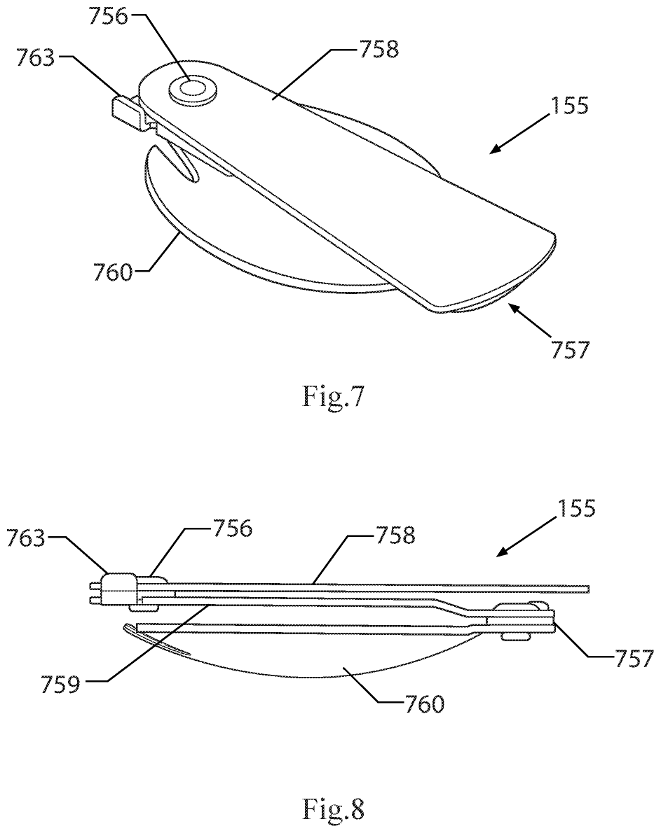

FIG. 7 is an illustration of a perspective view of one embodiment of a collapsible spork for use with the multi-functional reusable bottle of the present disclosure. FIG. 7 shows that one embodiment of the reusable and collapsible utensil may be a spork 155. The spork 155 may collapse in many ways, but is shown with two hinges 756, 757, end segment 758, and a tip segment 760. Hinge 756 may comprise a hinge stop 763, that prevents the end segment from freely rotating around hinge 756. FIG. 7 shows the spork 155 in a collapsed storage position with the three segments folded over each other to make the spork 155 as compact as possible.

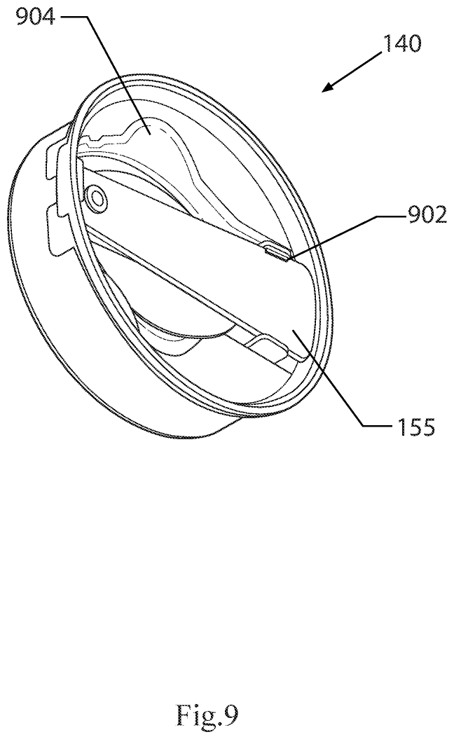

FIG. 8 is an illustration of a side view of one embodiment of a collapsible spork for use with the multi-functional reusable bottle of the present disclosure. As shown in FIG. 8, the spork 155 may comprise hinges 756, 757, end segment 758, middle segment 759, and a tip segment 760. Hinge 756 may comprise a hinge stop 763, that prevents the end segment from freely rotating around hinge 756. FIG. 8 shows the spork 155 in a collapsed storage position with the three segments 758, 759, 760 folded over each other to make the spork 155 as compact as possible. Although pivot hinges are shown, any type of collapsible mechanism may be used, such as 180 butterfly hinges.

FIG. 9 is an illustration of one embodiment of a utensil storage containing the collapsible spork. As shown in FIG. 9, the utensil storage insert 140 may matingly, securely, and/or snuggly hold spork 155. The insert 140 may comprise features such as friction snap protrusions 902, which may allow the spork 155 to ‘snap’ into place and not accidentally fall out, and/or finger indentations 904, which may allow a user to more easily pull the spork 155 out from the insert 140.

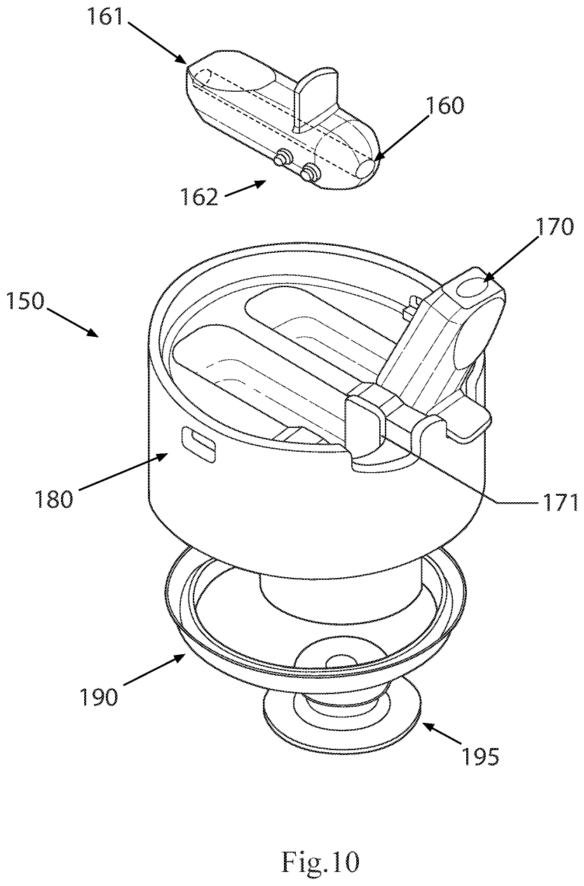

FIG. 10 is a partially exploded view of one embodiment of a cap assembly for use with the multi-functional reusable bottle of the present disclosure. As shown in FIG. 10, the cap assembly 150 may comprise first sip tip 160; second sip tip 170; cap 180; seal 190; and straw fitting 195. As shown, the cap assembly 150 may have two sip tips 160, 170, but in other embodiments, one or more than 2 sip tips may be used. The sip tips 160, 170 may removeably snap into the cap 180 for cleaning purposes. The sip tips 160, 170 may have a tube 161 and snap portions 162. The sip tips 160, 170 may have protrusion levers 171, which allow a user to hinge out the sip tip to be used. The sip tips may have a stored position and an in-use position, as shown by sip tip 170, which is shown in the in-use position.

The seal 190 may be an O-ring or a gasket that allows the cap assembly to tightly seal in liquid into the container 110 in a leak-proof manner. The cap 180 is the main portion of the cap assembly and may typically connect to the top of the container 110 in a threaded manner. The straw fitting 195 may act as a plug in the bottom part of the cap 180 and may allow a straw to removeably connect to the cap assembly 150.

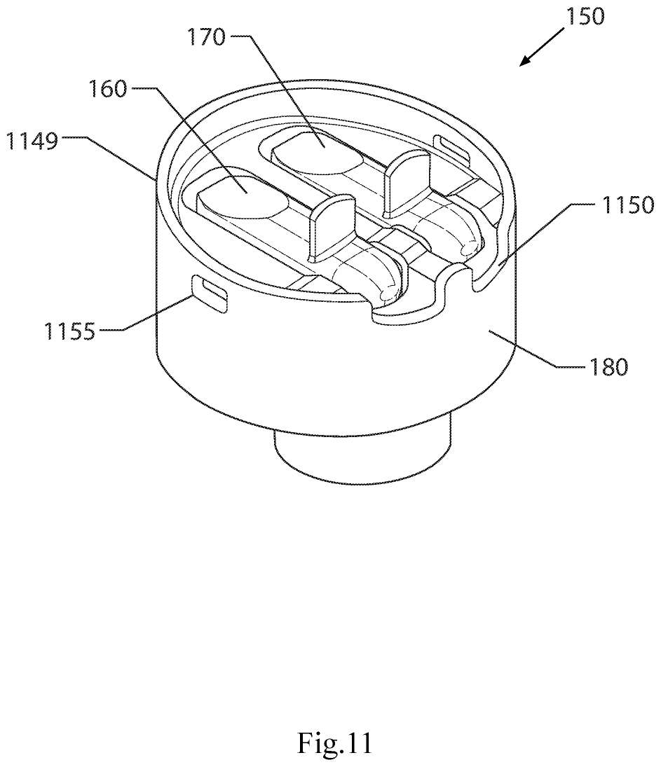

FIG. 11 is a perspective view of one embodiment of a cap assembly for use with the multi-functional reusable bottle of the present disclosure. FIG. 11 shows the sip tips 160, 170 in a closed position. Preferably when the sip tips 160, 170 are in a closed position, the container 110 is sealed. Preferably, the cap 180 may have a lip 1149 that rises higher than the protrusion levers when the sip tips 160, 170 are in a closed position. The lip 1149 may have notches 1150 that allow for the protrusion levers when the sip tips 160, 170 are open. The cap 180 may also have drain holes 1155 to prevent liquid from filling up the top of the cap 180.

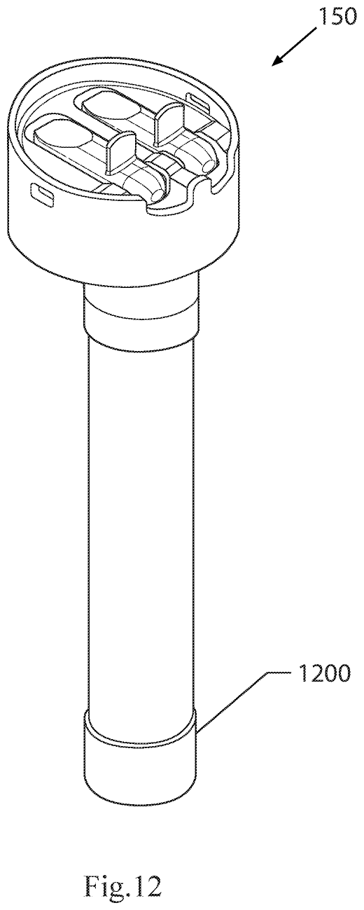

FIG. 12 is an illustration of one embodiment of a carbon filter for use with a multi-functional reusable bottle. As shown in FIG. 12, the straw may be replaced by a filter, such as carbon filter 1200. As shown in FIG. 12, the carbon filter 1200 may be connected to the cap assembly 150, such that using the bottle engages the carbon filter 1200 and allows the user to filter water automatically.

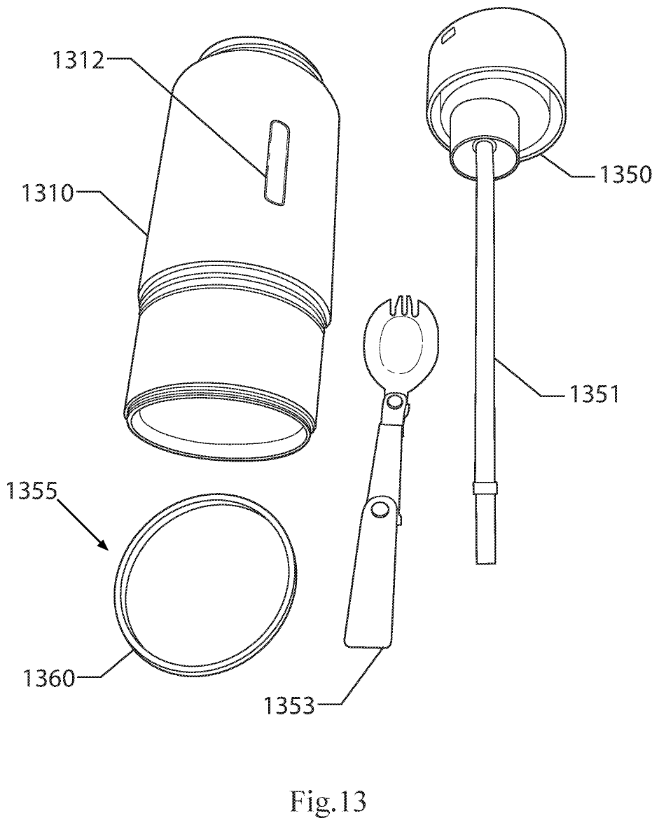

FIG. 13 is an illustration of one embodiment of a disassembled view of the multi-functional reusable bottle. As shown in FIG. 13, the multifunctional reusable bottle may comprise a container 1310, which may have a magnetic portion 1312 (which may be configured to engage with a magnetic portion on the removeable plate), cap assembly 1350, straw 1351, collapsible spork 1353, insert 1355, and insert cover 1360. FIG. 13 shows the spork 1353 in an extended position and ready to be used as a utensil.

Unless otherwise stated, all measurements, values, ratings, positions, magnitudes, sizes, locations, and other specifications, which set forth in this specification, including in the claims that follow, are approximate, not exact. They are intended to have a reasonable range, which is consistent with the functions to which they relate and with what is customary in the art to which they pertain.

The foregoing description of the preferred embodiment has been presented for the purposes of illustration and description. While multiple embodiments are disclosed, still other embodiments will become apparent to those skilled in the art from the above detailed description, which shows and describes the illustrative embodiments. As will be realized, these embodiments are capable of modifications in various obvious aspects, all without departing from the spirit and scope of the present disclosure. Accordingly, the detailed description is to be regarded as illustrative in nature and not restrictive. Also, although not explicitly recited, one or more additional embodiments may be practiced in combination or conjunction with one another. Furthermore, the reference or non-reference to a particular embodiment shall not be interpreted to limit the scope of protection. It is intended that the scope of protection not be limited by this detailed description, but by the claims and the equivalents to the claims that are appended hereto.

Except as stated immediately above, nothing which has been stated or illustrated is intended or should be interpreted to cause a dedication of any component, step, feature, object, benefit, advantage, or equivalent to the public, regardless of whether it is or is not recited in the claims.

What is claimed is:

1. A multi-functional reusable bottle, comprising:
a container;
a removable cup;
a utensil storage insert;
a utensil;
a removeable plate; and
a cap assembly;
wherein said utensil storage insert is configured to removably receive said utensil;
wherein said removable cup, said utensil, said removeable plate, and said cap assembly are configured to removeably attach to said container;
wherein said cap assembly is configured to attach to a top of said container;
wherein said removeable plate is configured to attach to a side of said container; and
wherein said removeable cup is configured to attach to a bottom of said container, such that said utensil and said utensil storage insert are concealed when said removeable cup is attached to said container.

2. The multi-functional reusable bottle of claim 1, wherein said utensil is collapsible and comprises one or more hinges, such that said utensil may compact by rotating along said hinges.

3. The multi-functional reusable bottle of claim 2, wherein said utensil is a spork.

4. The multi-functional reusable bottle of claim 1, wherein said removable cup and said container are configured to threadedly engage one another.

5. The multi-functional reusable bottle of claim 1, wherein said utensil storage insert removeably engages said bottom of said bottle.

6. The multi-functional reusable bottle of claim 1, wherein said utensil storage insert is part of said bottom of said container.

7. The multi-functional reusable bottle of claim 1, further comprising an insert cover that is configured to cover said utensil storage insert.

8. The multi-functional reusable bottle of claim 1, wherein said cap assembly comprises one or more sip tips, a cap, a straw fitting, and a straw;
wherein said straw fitting is configured to engage said straw.

9. The multi-functional reusable bottle of claim 8, wherein said straw is removeably engageable with said straw fitting.

10. The multi-functional reusable bottle of claim 9, wherein there are two sip tips.

11. The multi-functional reusable bottle of claim 1, further comprising a filter that is configured to engage with said cap assembly.

12. The multi-functional reusable bottle of claim 1, wherein said bottom of said container is flat, such that said bottle is configured to stand upright on flat surfaces when said removable cup is removed from said container.

13. The multi-functional reusable bottle of claim 1, wherein a bottom of said reusable cup is flat, such that said bottle is configured to stand upright on flat surfaces when said removable cup is attached to said container.

14. The multi-functional reusable bottle of claim 1, wherein said container is insulated.

15. The multi-functional reusable bottle of claim 1, wherein said removeable plate is configured to removeably attach to said container via one or more magnets.

16. The multi-functional reusable bottle of claim 15, wherein said removeable plate comprises a plate magnet and wherein said container comprises a container magnet;
wherein said plate magnet and said container magnet are configured to matingly engage, such that said removeable plate is substantially prevented from accidentally coming off said container when said plate magnet and said container magnet are engaged.

17. A multi-functional reusable bottle, comprising:
a container;
a removable cup;
a utensil storage insert;
an insert cover that is configured to cover said utensil storage insert;
a utensil;
a removeable plate; and
a cap assembly;
wherein said utensil storage insert is configured to removably receive said utensil;
wherein said removable cup, said utensil, said removeable plate, and said cap assembly are configured to removeably attach to said container;
wherein said cap assembly is configured to attach to a top of said container;
wherein said removeable plate is configured to attach to a side of said container; and
wherein said removeable cup is configured to attach to a bottom of said container, such that said utensil and said utensil storage insert are concealed when said removeable cup is attached to said container;
wherein said utensil is collapsible and comprises one or more hinges, such that said utensil may compact by rotating along said hinges;
wherein said cap assembly comprises one or more sip tips and a cap; and
wherein said removeable plate is configured to removeably attach to said container via one or more magnets.

18. The multi-functional reusable bottle of claim 17, wherein said utensil storage insert removeably engages said bottom of said bottle.

19. The multi-functional reusable bottle of claim 17, further comprising a filter that is configured to engage with said cap assembly.

20. A multi-functional reusable bottle, comprising:
a container;
a removable cup;
a utensil storage insert;
an insert cover that is configured to cover said utensil storage insert;
a utensil;
a removeable plate; and
a cap assembly;
wherein said utensil storage insert is configured to removably receive said utensil;
wherein said removable cup, said utensil, said removeable plate, and said cap assembly are configured to removeably attach to said container;
wherein said cap assembly is configured to attach to a top of said container;
wherein said removeable plate is configured to attach to a side of said container; and
wherein said removeable cup is configured to attach to a bottom of said container, such that said utensil and said utensil storage insert are concealed when said removeable cup is attached to said container;
wherein said utensil is collapsible and comprises one or more hinges, such that said utensil may compact by rotating along said hinges;
wherein said utensil is a spork;
wherein said removable cup and said container are configured to threadedly engage one another;
wherein said cap assembly comprises one or more sip tips, a cap, a straw fitting, and a straw;
wherein said straw fitting is configured to engage said straw;
wherein said bottom of said container is flat, such that said bottle is configured to stand upright on flat surfaces when said removable cup is removed from said container;
wherein a bottom of said reusable cup is flat, such that said bottle is configured to stand upright on flat surfaces when said removable cup is attached to said container;
wherein said container is insulated; and
wherein said removeable plate is configured to removeably attach to said container via one or more magnets.
